(19) United States
(12) Patent Application Publication
(10) Pub. No.: US 2008/0067018 A1
(43) Pub. Date: Mar. 20, 2008

(54) Brake disk

(75) Inventors: Philip John Smith, Sutton Coldfield (GB); David Gabriel MacManus, Lavendon Olney (GB)

Correspondence Address: BARNES & THORNBURG LLP, P.O. BOX 2786, CHICAGO, IL, 60690-2786, US

(73) Assignee: Alcon components Limited

(21) Appl. No.: 11/602,110

(22) Filed: Nov. 17, 2006

Related U.S. Application Data
(60) Provisional application No. 60/826,185, filed on Sep. 19, 2006.

(51) Int. Cl. F16D 65/12

(52) U.S. Cl. 188/218 XL

(57) ABSTRACT

A brake disk with enhanced cooling features. The brake disk defines a plurality of channels with ribs located within those channels. Two friction plates are connected together by way of a plurality of vanes. The vanes define channels through which cooling air travels. The ribs extend from the surface of friction plates and are chevron shaped. The channels extend between an inner diameter of the brake disk and an outer diameter and direct cooling air from radially inner regions of the brake disk. The ribs create increased air turbulence and flow features which provide greater heat transfer, thereby providing improved cooling.

### CROSS-REFERENCE TO RELATED APPLICATIONS

This application claims priority to Provisional Application Number 60/826185, filed Sep. 19, 2006, which is incorporated herein by reference.

### FIELD OF THE INVENTION

The present disclosure is directed to a brake disk for a disk brake system.

### BACKGROUND

Disk brake systems are particularly suitable for high performance motor vehicles, such as racing cars, high-powered motor vehicles, heavy vehicles, vehicles pulling trailers, etc. Such disk brake systems consist of a caliper, a brake disk, and a center hub. During braking, hydraulic pressure is applied to the pistons within the brake caliper and the caliper pads make contact with the friction plate of the brake disk. The kinetic energy of the vehicle is converted into thermal energy due to friction between the caliper pads and friction plates of the brake disk. As a result, the caliper pads and friction plates become heated, and the heat must be dissipated as quickly as possible to prevent overheating of the components of the disk brake system.

### SUMMARY

The present disclosure relates to a brake disk for a disk brake system defining a plurality of channels and including a plurality of ribs disposed within each of the channels. The brake disk may comprise a pair of opposed friction plates and a plurality of vanes disposed between the friction plates defining the channels. The vanes and ribs may extend from the surface of one of the friction plates toward the other friction plate. The ribs may interconnect the vanes or otherwise extend from one vane to the other vane, and may be chevron shaped or have any other suitable shape. The channels may extend between an inner diameter of the brake disk and an outer diameter and direct cooling air from the radially inner regions of the brake disk.

Additional features of the present disclosure will become apparent to those skilled in the art upon consideration of the following Detailed Description.

### DESCRIPTION OF THE DRAWINGS

FIG. 1 is a perspective view of a disk brake system having a brake disk in accordance with an illustrated embodiment of the present disclosure;

FIG. 2 is a cutaway perspective view of the brake disk of FIG. 1; and

FIG. 3 is a cross-sectional view of the brake disk of FIG. 1, illustrating the cross section of the ribs and brake disk.

### DETAILED DESCRIPTION

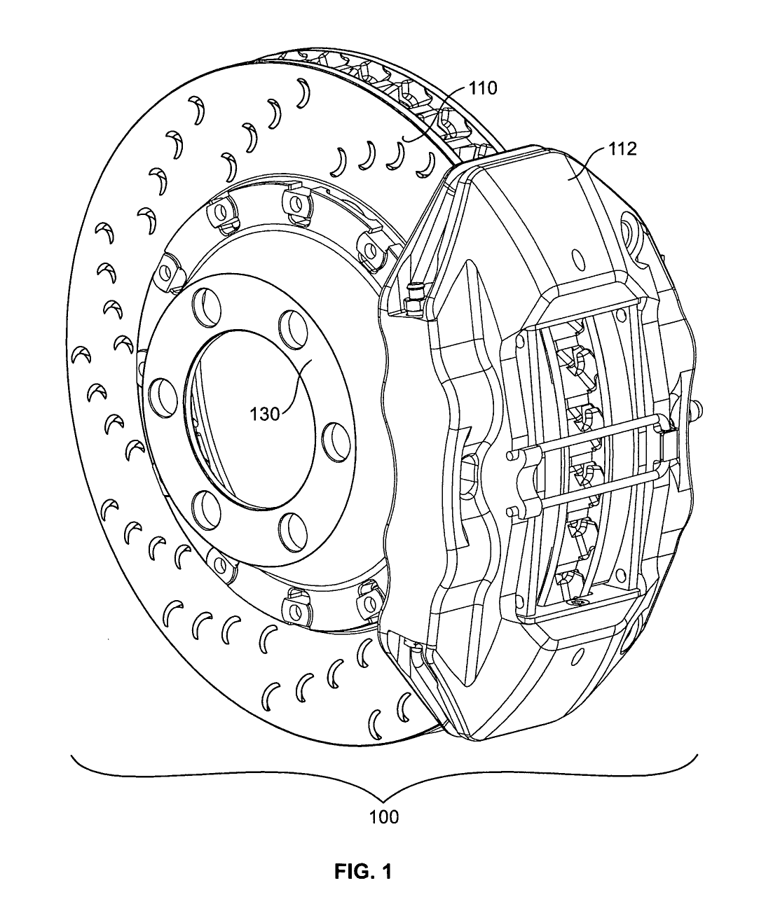

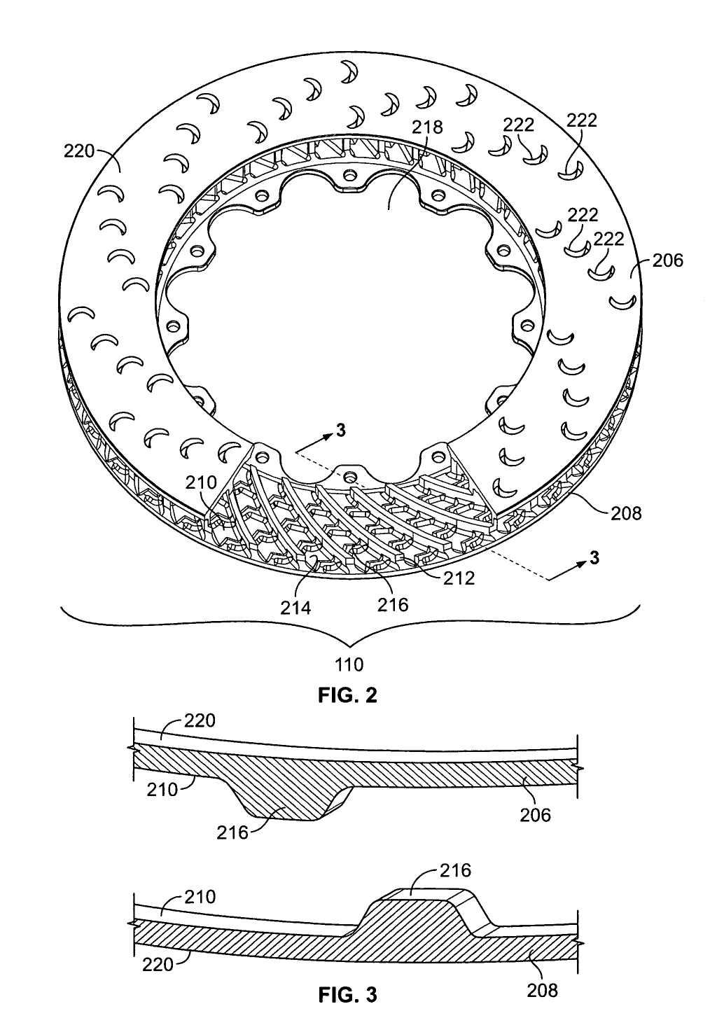

FIGS. 1-3 illustrate a disk brake system 100 comprising a brake disk 110 in accordance with an embodiment of the present disclosure, a caliper 112, and a center hub 130. The caliper 112 is disposed about the brake disk 110, and the center hub 130 is coupled to the inner diameter of the brake disk 110. The center hub 130 is attached to a vehicle wheel and rotates the brake disk 1 10.

The brake disk 110 includes a pair of opposed friction plates 206 and 208, a plurality of vanes 212 disposed between the friction plates and defining a plurality of channels 214 between the friction plates, and a plurality of ribs 216 disposed within the channels 214. The brake disk 110 further defines a center hole 218. Each of the friction plates 206 and 208 includes an outer face 220 and an inner face 210. The outer faces 220 of the friction plates 206 and 208 may also define a plurality of crescent shaped-grooves 222.

The friction plates 206 and 208 are interconnected by the plurality of vanes 212. The vanes 212 may be formed or cast as part of either friction plate 206 or 208 on the friction plate inner faces 210. The vanes 212 may instead be formed as part of both friction plates 206 and 208 or may be formed as a separate structure. The vanes 212 extend in a curved or other aerodynamic manner between the inner diameter of the brake disk 110 and the outer diameter of the brake disk 110. The vanes 212 can instead begin and terminate at any other point within the brake disk 110, and may have any other suitable configuration in accordance with other embodiments.

A plurality of the ribs 216 are disposed within each of the channels 214. The ribs 216 extend from the inner face 210 of each of the friction plates 206 and 208, between the vanes 212. The ribs 216 interconnect the vanes 212. However, the ribs 216 may also not interconnect the vanes 212. The ribs 216 are chevron or “v” shaped with the apex being disposed nearest the inner diameter brake disk 110, opposing the air flow.

The ribs 216 on the friction plate 206 are offset relative to the ribs 216 of the friction plate 208. The ribs 216 on each friction plate can also be directly across from each other. An offset of ribs 216 is generally desirable, however, to minimize the reduction in air flow through the channels 214. The spacing, placement, shape and number of the ribs 216 can be optimized for the given circumstances.

The ribs 216 may be disposed anywhere else within the channels 214 in accordance with other embodiments. The ribs 216 can be added to the vanes 212 in addition to or instead of the friction plates 206 and 208. The ribs 216 also can be formed or otherwise disposed on only one friction plate or otherwise arranged or disposed in any other suitable manner. The ribs 216 can also be individually located within the channel 214, without contacting either vane 212.

Each of the ribs 216 has a rectangular cross-section. The ratio of the height of the ribs 216 divided by the height of the vanes 212 may be roughly equal to 0.125. The ribs 216, however, may have any other suitable cross-section. For example, the cross section of the ribs 216 can be rounded, pointed, or have any other suitable cross-section. The ribs 216 can also have any suitable height. The height, width, shape, length, number, and position of the ribs 216 can be widely varied. The ribs 216 can have any other shape in accordance with other embodiments. For example, the ribs 216 can be straight, curved, convex, concave, reverse chevron etc. The ribs 216 also can have any geometric shape, including rectangular or cylindrical discrete appendages.

The ribs 216 consist of cast iron and are manufactured with a conventional method for this type of product; using a rigid sand core produced from a split corebox placed in a hard sand mould produced by a pattern. The ribs 216 are cast as a part of the friction plates 206 and 208. The ribs 216 can be made from any suitable material for these temperatures, can be formed using any manufacturing process, and can be attached via a welding process or mechanically or with an adhesive rather than being cast as part of the friction plates 206 and 208. The ribs 216 can also be cast onto or attached to the vanes 212 instead of the friction plates 206 and 208. The ribs 216 can be cast onto any structure within the channel 214. In addition, the entire brake disk 110, with friction plates 206 and 208, vanes 212, and ribs 216, can be cast as a single component using an investment casting process with a dissolvable core or other suitable casting technique.

In operation of the disk brake system 100, the vehicle wheel turns the center hub 130, which turns the brake disk 110. During braking, pistons within the caliper 112 are engaged and pads within the caliper 112 move to contact the outer faces 220 of the friction plates of the brake disk 110. The contact with the outer faces 220 of the friction plates 206 and 208 and pads causes friction as the kinetic energy of the vehicle is converted to thermal energy or heat. As a result, the brake disk 110, center hub 130, and vehicle wheel slow and the brake disk 110 becomes heated. As the brake disk 110 rotates, air is drawn into the channels 214 at the brake disk 110 inside diameter and exits at the brake disk 110 outer diameter. As the air travels within the channels 214, heat is extracted from the brake disk 110. The crescent shaped-grooves 222 may perform various functions, such as, for example, drainage of foreign material from the friction plate outer faces 220 and pads, and counter acting brake shudder or pulsing.

The ribs 216 inside the channels 214 of the brake disk 110 in accordance with the illustrated embodiment improve massflow and heat transfer coefficients by causing turbulence and high heat transfer flow features within the channels 214. This turbulence may improve aerodynamic mixing between air traveling in the center of the channel 214 and air traveling closer to the disk inner faces 210 and vanes 212, create local attachment points which increase local heat transfer coefficient, and create secondary flows of air which promote the redistribution of massflow to enhance heat transfer. The shape of ribs 216 may reduce total pressure loss.

While the above description contains many specificities, these should not be construed as limitations on the scope of the disclosure but rather as an explanation of one preferred embodiment thereof. Many other variations are possible. Accordingly the scope of the disclosure should be determined not by the embodiment illustrated but by the appended claims and their legal equivalents.

The claimed invention is:

1. A brake disk for a disk brake system defining a plurality of channels and comprising a plurality of ribs, at least one rib disposed within each channel.

2. The brake disk of claim 1, further comprising two opposed friction plates coupled together defining the plurality of channels.

3. The brake disk of claim 2, further comprising a plurality of vanes disposed between the friction plates further defining the plurality of channels.

4. The brake disk of claim 3, wherein the plurality of vanes extend from a face of at least one of the friction plates.

5. The brake disk of claim 3, wherein the ribs extend from a face of at least one of the friction plates.

6. The brake disk of claim 3, wherein the ribs extend from a face of at least one of the vanes.

7. The brake disk of claim 3, wherein the ribs interconnect the vanes.

8. The brake disk of claim 2, wherein some of the ribs extend from a face of one of the friction plates and some of the other ribs extend from a face of the other friction plate.

9. The brake disk of claim 8, wherein said some of the ribs are offset relative to said some of the other ribs.

10. The brake disk of claim 2, wherein the ribs are chevron shaped.

11. The brake disk of claim 2, wherein the opposed friction plates define a central hole of the brake disk and wherein the channels extend from an inner diameter of the brake disk to an outer diameter of the brake disk to direct cooling air from radially inner regions.

12. The brake disk of claim 1, wherein each of the ribs has a substantially rectangular cross-section.

13. The brake disk of claim 1, wherein more than one rib is disposed within each channel.

14. The brake disk of claim 1, wherein the brake disk is comprised of cast iron.

15. A brake disk for a disk brake system comprising:
a) two opposed friction plates coupled together,
b) a plurality of vanes disposed between the friction plates defining a plurality of channels, and
c) a plurality of ribs disposed within each channel.

16. The brake disk of claim 15, wherein the ribs extend from the surface of at least one of the friction plates.

17. The brake disk of claim 15, wherein the ribs extend from the surface of at least one of the vanes.

18. The brake disk of claim 15, wherein the ribs interconnect the vanes.

19. The brake disk of claim 15, wherein some of the ribs extend from a face of one of the friction plates and some of the other ribs extend from a face of the other friction plate.

20. The brake disk of claim 19, wherein said some of the ribs are offset relative to said some of the other ribs.

21. The brake disk of claim 15, wherein the opposed friction plates define a central hole of the brake disk and wherein the channels extend between an inner diameter of the brake disk and an outer diameter of the brake disk to direct cooling air from radially inner regions.

22. A brake disk for a disk brake system comprising:
a) two opposed friction plates having inner faces;
b) a plurality of vanes coupling together the two friction plates, the vanes extending from the face of at least one of the friction plates and defining channels for directing cooling air; and
c) a plurality of ribs extending from the face of at least one of the friction plates and disposed within each of the channels.

23. The brake disk of claim 22, wherein the ribs extend from the surface of at least one of the friction plates.

24. The brake disk of claim 22, wherein the ribs extend from a surface of at least one of the vanes.

25. The brake disk of claim 22, wherein the ribs interconnect the vanes.

26. The brake disk of claim 22, wherein some of the ribs extend from a face of one of the friction plates and some of the other ribs extend from a face of the other friction plate.

27. The brake disk of claim 26, wherein said some of the ribs are offset relative to said some of the other ribs.

28. The brake disk of claim 22, wherein the opposed friction plates define a center hole of the brake disk and wherein the channels extend between an inner diameter of the brake disk and an outer diameter of the brake disk to direct cooling air from radially inner regions.
